(19) United States
(12) Patent Application Publication
(10) Pub. No.: US 2010/0191452 A1
(43) Pub. Date: Jul. 29, 2010

(54) ROUTE SEARCHING APPARATUS, ROUTE SEARCHING METHOD AND PROGRAM

(75) Inventors: Yuhki Matsumoto, Tsurugashima (JP); Shinya Yoshida, Tokorozawa (JP); Hiroshi Seo, Omiya (JP)

Correspondence Address: YOUNG & THOMPSON, 209 Madison Street, Suite 500, Alexandria, VA, 22314, US

(73) Assignee: PIONEER CORPORATION, Tokyo (JP)

(21) Appl. No.: 12/666,589

(22) PCT Filed: Jun. 29, 2007
(86) PCT No.: PCT/JP2007/063101

§ 371 Date: Dec. 23, 2009

(51) Int. Cl. G01C 21/00

(52) U.S. Cl. 701/200

(57) ABSTRACT

A route searching device performs route searching according to a search condition such as, for example, a user specification and calculates candidate routes. For the obtained candidate routes, a facility learning effect index is calculated on a per-route basis, and the candidate routes are presented according to the facility learning effect indices. The facility learning effect index here indicates, for each of the candidate routes, the degree of learning effect of learning the facilities existing on the route. Accordingly, a route can be obtained that has a high learning effect of learning the facilities on the route.

### TECHNICAL FIELD

This invention relates to a method of searching a route.

### BACKGROUND TECHNIQUE

In a navigation apparatus, there is known a route searching function which calculates a route to a destination and presents it to a user. Generally, since the route searching function calculates the route such that the required time to the destination becomes shortest, usually the same route is presented if the starting point and the destination are the same. However, if the user travels only the same route in this way, the user can obtain information of areas and facilities on the route, but cannot obtain knowledge of facilities existing in other areas.

There is proposed a method of calculating, in a navigation apparatus, user's knowledge degree with respect to areas by utilizing travel history in the past, and providing the navigation with using the knowledge degree. For example, Patent Reference-1 discloses a method of calculating area knowledge degree for each traveled area, and enlarging and/or reducing the object in the destination search in accordance with the area knowledge degree. Also, Patent Reference-2 discloses varying map network range used for the route search in accordance with whether or not the starting point and the destination belong to known area.

Patent Reference-1: Japanese Patent Application Laid-open under No. 2003-83759

Patent Reference-2: Japanese Patent Application Laid-open under No. 11-213289

### DISCLOSURE OF INVENTION

### Problem to be Solved by the Invention

The above is an example of the problem to be solved by the present invention. It is an object of the present invention to provide a route searching method by which a user can obtain information of facilities in broad areas by travelling the route presented by the route search.

### Means for Solving the Problem

According to the invention of claim 1, a route searching apparatus includes: a route searching means which performs a route search according to a search condition; an index calculating means which calculates a facility learning effect index indicating a degree of learning effect of a facility existing on a route, for each of candidate routes obtained by the route search; and a candidate route presenting means which presents candidate routes based on the facility learning effect index.

According to the invention of claim 8, a route searching method includes: a route searching process which performs a route search according to a search condition; an index calculating process which calculates a facility learning effect index indicating a degree of learning effect of a facility existing on a route, for each of candidate routes obtained by the route search; and a candidate route presenting process which presents candidate routes based on the facility learning effect index.

According to the invention of claim 9, a route searching program, which is executed by a terminal device including a computer, makes the computer function as: a route searching means which performs a route search according to a search condition; an index calculating means which calculates a facility learning effect index indicating a degree of learning effect of a facility existing on a route, for each of candidate routes obtained by the route search; and a candidate route presenting means which present candidate routes based on the facility learning effect index.

### BRIEF DESCRIPTION OF THE DRAWINGS

FIG. 1 is a block diagram showing a configuration of a navigation apparatus according to the present invention;

FIG. 2 is a block diagram showing a functional configuration of a navigation apparatus according to a first embodiment;

FIG. 3 shows an example of facility data;

FIG. 4 is a graph showing an example of calculating method of facility learning degree;

FIG. 5 is a flowchart of a route presenting process according to the first embodiment;

FIGS. 6A and 6B show examples of determining the route to be presented by the route presenting process;

FIG. 7 is a block diagram showing a functional configuration of a navigation apparatus according to a second embodiment; and

FIG. 8 is a flowchart showing of a route presenting process according to the second embodiment.

### DESCRIPTION OF REFERENCE NUMBERS

10 Stand-Alone position measurement device
20 System controller
40 Display unit
60 Input device
110 Facility learning degree calculating unit
112 Facility importance degree calculating unit
114 Learning purpose route calculating unit
116 Margin determining unit

### PREFERRED FORM TO EXCESIZE THE INVENTION

According to a preferred form of the present invention, there is provided a route searching apparatus including: a route searching means which performs a route search according to a search condition; an index calculating means which calculates a facility learning effect index indicating a degree of learning effect of a facility existing on a route, for each of candidate routes obtained by the route search; and a candidate route presenting means which presents candidate routes based on the facility learning effect index.

The above route searching apparatus performs a route search according to a search condition designated by a user, for example, and calculates candidate routes. A facility learning effect index is calculated for each of the candidate routes, and the candidate routes are presented based on the facility learning effect index. The facility learning effect index indicates a degree of learning effect of the facility existing on the route, for each of the candidate routes. Therefore, it is possible to obtain a route having a high learning effect for the facility existing on the route.

According to one mode of the above route searching apparatus, the index calculating means includes: a learning effect calculating means which calculates a facility learning effect for each of facilities existing on the candidate routes; and a learning effect index calculating means which calculates a total of the facility learning effects of all the facilities existing on the candidate route as the learning effect index. By this, it is possible to obtain a total learning effect with respect to a plurality of facilities on the route, for each of the candidate routes.

According to another mode of the above route searching apparatus, the index calculating means includes: a learning effect calculating means which calculates a facility learning effect for each of the facilities existing on the candidate routes; a correcting means which corrects the facility learning effect by an importance degree set to the facility; and a learning effect index calculating means which calculates a total of corrected facility learning effects of all the facilities existing on the candidate route as the learning effect index. By this, the learning effect can be calculated in consideration of the importance degree of each facility, and it is possible to present, to the user, a route having a high learning effect with respect to the facility having high importance degree.

According to another mode of the above route searching apparatus, a margin determining means which determines whether or not the candidate route satisfies a margin condition is further included, and the index calculating means calculates the facility learning effect index only for the candidate route satisfying the margin condition. By this, it is possible to present a route in consideration of the learning effect within a range of the user's margin. In a preferred example, the margin condition is a necessary time to a destination set in advance.

According to still another mode of the above route searching apparatus, the candidate route presenting means sets the candidate route having a highest learning effect index to a guiding route. According to still another mode, the candidate route presenting means presents the candidate routes in an order from the candidate route having a higher learning effect index.

According to another preferred form of the present invention, there is provided a route searching method including: a route searching process which performs a route search according to a search condition; an index calculating process which calculates a facility learning effect index indicating a degree of learning effect of a facility existing on a route, for each of candidate routes obtained by the route search; and a candidate route presenting process which presents candidate routes based on the facility learning effect index. Also by this method, it is possible to present, to the user, a route having a high learning effect with respect to the facility on the route.

According to still another preferred form of the present invention, there is provided a route searching program executed by a terminal device including a computer, making the computer function as: a route searching means which performs a route search according to a search condition; an index calculating means which calculates a facility learning effect index indicating a degree of learning effect of a facility existing on a route, for each of candidate routes obtained by the route search; and a candidate route presenting means which present candidate routes based on the facility learning effect index. By executing the program by the computer, the above route searching apparatus can be realized.

### EMBODIMENT

Preferred embodiments of the present invention will be described below with reference to the attached drawings.

[Configuration of Navigation Apparatus]

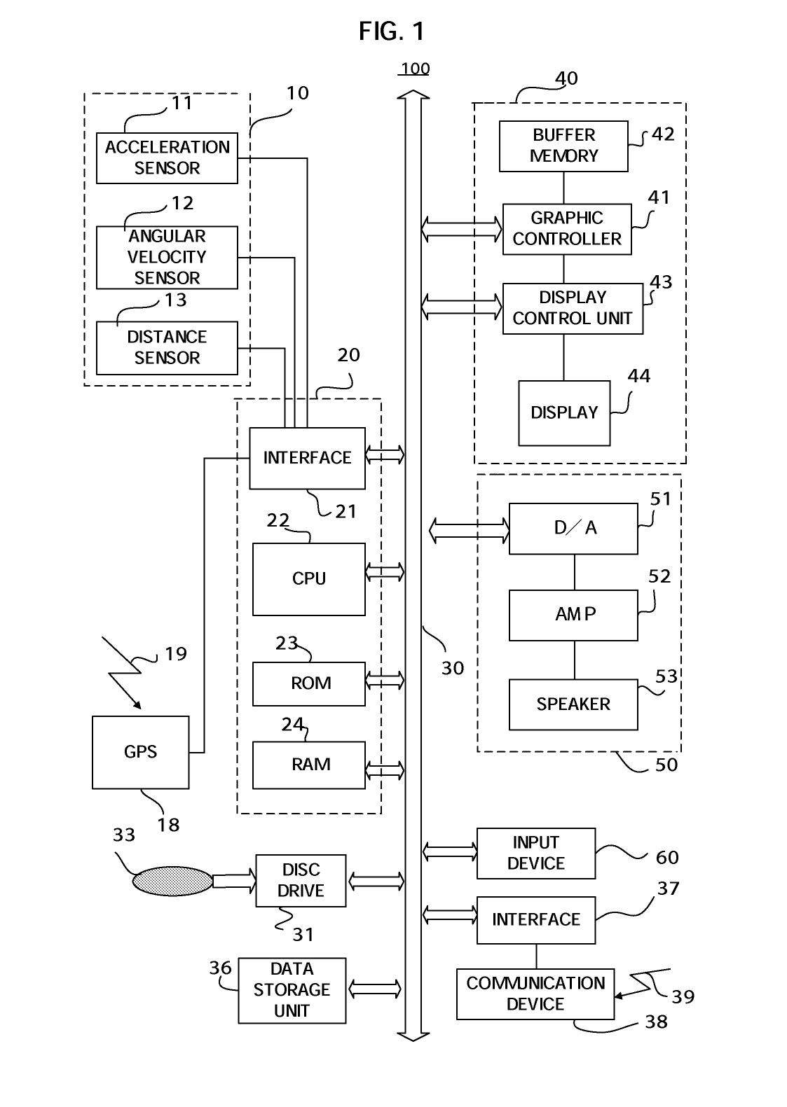

FIG. 1 shows a configuration of a navigation apparatus 100 according to an embodiment of the present invention. As shown in FIG. 1, the navigation apparatus 100 includes a stand-alone position measurement device 10, a GPS receiver 18, a system controller 20, a disc drive 31, a data storage unit 36, a communication interface 37, a communication device 38, a display unit 40, a sound output unit 50, and an input device 60.

The stand-alone position measurement device 10 includes an acceleration sensor 11, an angular velocity sensor 12 and a distance sensor 13. The acceleration sensor 11 includes a piezoelectric element, for example, and detects the acceleration degree of the vehicle and outputs the acceleration data. The angular velocity sensor 12 includes a vibration gyroscope, for example, and detects the angular velocity of the vehicle at the time of changing the direction of the vehicle and outputs the angular velocity data and the relative direction data. The distance sensor 13 measures vehicle speed pulses including a pulse signal generated with the wheel rotation of the vehicle.

The GPS receiver 18 receives an electric wave 19 for transmitting downlink data including position measurement data from plural GPS satellites. The position measurement data is used for detecting the absolute position of the vehicle from longitude and latitude information.

The system controller 20 includes an interface 21, a CPU 22, a ROM 23 and a RAM 24, and controls the entire navigation apparatus 100.

The interface 21 executes the interface operation with the acceleration sensor 11, the angular velocity sensor 12, the distance sensor 13 and the GPS receiver 18. Then, the interface 21 inputs the vehicle speed pulse, the acceleration data, the relative direction data, the angular velocity data, the GPS measurement data and the absolute direction data into the system controller 20. The CPU 22 controls the entire system controller 20. The ROM 23 includes a non-volatile memory, not shown, in which control programs for controlling the system controller 20 are stored. The RAM 24 readably stores various kinds of data such as route data preset by the user via the input device 60, and supplies a working area to the CPU 22.

The system controller 20, the disc drive 31 such as a CD-ROM drive or a DVD-ROM drive, the data storage unit 36, the communication interface 37, the display unit 40, the sound output unit 50 and the input device 60 are connected to each other via a bus line 30.

Under the control of the system controller 20, the disc drive 31 reads contents data such as sound data and video data from a disc 33 such as a CD and a DVD to output the contents data.

The disc drive 31 may be the CD-ROM drive or the DVD-ROM drive, or may be a drive compatible between the CD and the DVD.

The data storage unit 36 includes HDD, for example, and stores various kinds of data, such as map data and facility data, used for a navigation process.

The communication device 38 includes an FM tuner, a beacon receiver, a mobile phone or a dedicated communication card, for example, and obtains various information such as traffic jam information and/or traffic information distributed by a VICS (Vehicle Information Communication System) center via the communication interface 37.

The display unit 40 displays various kinds of display data on a display device such as a display under the control of the system controller 20. Concretely, the system controller 20 reads the map data from the data storage unit 36. The display unit 90 displays, on a display screen such as a display, the map data read from the data storage unit 36 by the system controller 20. The display unit 40 includes a graphic controller 41 for controlling the entire display unit 40 on the basis of the control data transmitted from the CPU 22 via the bus line 30, a buffer memory 42 having a memory such as a VRAM (Video RAM) for temporarily storing immediately displayable image information, a display control unit 43 for controlling a display 44 such as a liquid crystal and a CRT (Cathode Ray Tube) on the basis of the image data outputted from the graphic controller 41, and the display 44. The display 44 is formed by a liquid crystal display device of the opposite angle 5-10 inches, and is mounted in the vicinity of a front panel of the vehicle.

The sound output unit 50 includes a D/A converter 51 for executing D/A conversion of the sound digital data transmitted from the disc drive 31 or the RAM 24 via the bus line 30 under the control of the system controller 20, an amplifier (AMP) 52 for amplifying a sound analog signal outputted from the D/A converter 51, and a speaker 53 for converting the amplified sound analog signal into the sound and outputting it to the vehicle compartment.

The input device 60 includes keys, switches, buttons, a remote controller and a sound input device, which are used for inputting various kinds of commands and data. The input device 60 is arranged in the vicinity of the display 44 and a front panel of a main body of an on-vehicle electric system loaded on the vehicle. Additionally, in such a case that the display 49 is a touch panel system, a touch panel provided on the display screen of the display 44 functions as the input device 60, too.

### 1st Embodiment

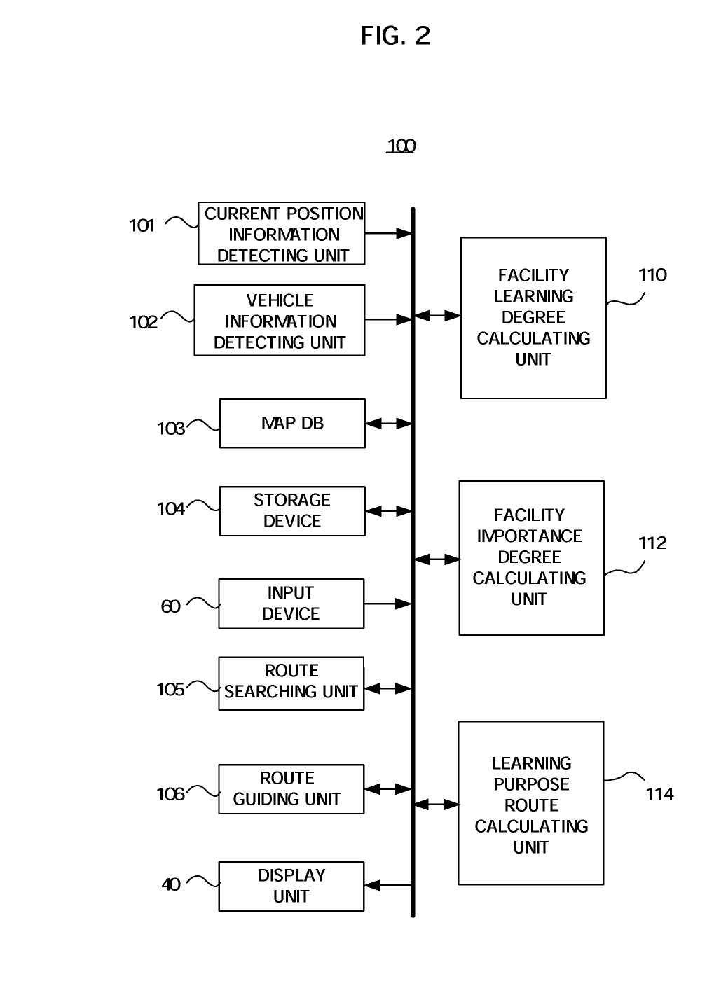

FIG. 2 is a functional block diagram of a first embodiment of the navigation apparatus according the present invention. These functions are realized by the constitutional elements shown in FIG. 1.

The navigation apparatus 100 includes a current position information detecting unit 101, a vehicle information detecting unit 102, a map database 103, a storage device 104, an input device 60, a route searching unit 105, a route guiding unit 106, a display unit 40, a facility learning degree calculating unit 110, a facility importance degree calculating unit 112 and a learning purpose route calculating unit 119.

The current position information detecting unit 101 is constituted by the stand-alone position measurement device 10 and the GPS 18 shown in FIG. 1, and detects the current position of the vehicle on which the navigation apparatus 100 is installed. The vehicle information detecting unit 102 is constituted by the stand-alone position measurement device 10, and detects the vehicle speed pulses and the direction of the vehicle.

The map database 103 is constituted by the data storage unit 36, and stores the map data. The map data includes facility data which is data relating to the facility.

The storage device 104 is constituted by the RAM 24, for example, and functions as a working memory for the route presenting process described later to temporality store various information. The route searching unit 105 performs the route search to the destination. The route guiding unit 106 executes the route guidance according to the guiding route by the display on the screen and/or the voice.

The facility learning degree calculating unit 110 calculates the facility learning degree, which is a user's learning degree with respect to the facility. The facility importance degree calculating unit 112 calculates the importance degree for each facility. The importance degree is used to perform the weighted correction of the learning degree at the time of calculating the learning degree for each route. The learning purpose route calculating unit 114 calculates a learning purpose route based on the facility learning degree calculated by the facility learning degree calculating unit 110.

The route searching unit 105, the route guiding unit 106, the facility leaning degree calculating unit 110, the facility importance degree calculating unit 112 and the learning purpose route calculating unit 114 are realized by the CPU 22 in the system controller 20 executing a program prepared in advance.

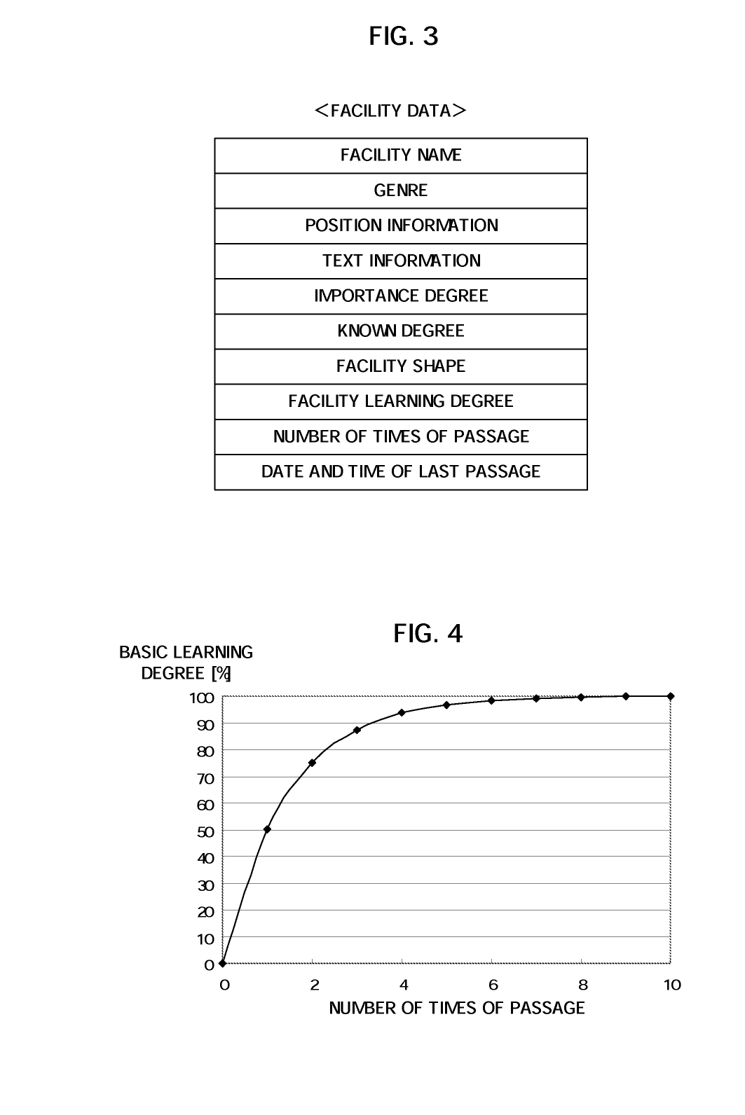

Next, the facility data will be described in detail. An example of the facility data is shown in FIG. 3. The facility data is prepared for each of the geographic facilities. The facility data includes a facility name, a genre, position information, text information, a importance degree, a known degree, a facility shape, a learning degree, a number of times of passage, and date and time of last passage.

The “facility name” is a specific name of the facility, such as “A-Park”, “B-City Hall”. The “genre” is a kind of the facility, such as a play-spot for a park and a public facility for a city hall. The “position information” is geographic position information of the facility, which is normally represented by latitude and longitude. The “text information” is character data of information associated with the facility, such as business hours and a telephone number of a shop.

The “importance degree” is a value used by the facility importance degree calculating unit 112 described later, and is used for weighting the facility learning degree. The “known degree” is a value showing how much the facility is generally known. The “facility shape” indicates the external shape of the facility. The “facility learning degree” is a value indicating how much the user has the knowledge about the facility, and is calculated by the facility learning degree calculating unit 110 described later. The “number of times of passage” is a number of times that the user passes the nearby area of the facility in the past, and the “date and time of last passage” is the date and time that the user passed the nearby area of the facility at the last time.

Next, the facility learning degree calculating unit 110 will be described in detail. The facility learning degree calculating unit 110 calculates the facility learning degree, which is a learning degree with respect to each of the facilities on the candidate routes obtained by the route search performed according to the search condition designated by the user. Basically, the facility learning degree is set to be high, as the number of times of passing the nearby area of the facility is high. In this example, when the number of times of passage is expressed by “x”, the basic learning degree [%] is given by the following equation (1) and is shown by the graph in FIG. 4.

$$Learning Degree ( \% ) = \{ 1 - {( \frac{1}{2} )}^{X} \} \times 100 \qquad ( 1 )$$

The final facility learning degree is determined based on the basic learning degree obtained by the above equation (1), in consideration of various parameters listed below as examples. Also, the facility learning degree may be edited by the user's input. Many parameters are conceivable, mainly including four parameters: a driving factor, a facility factor, a route factor and a human factor.

(a) Driving Factor

The driving factor is a parameter derived from the vehicle driving situation at the time of passing the facility. For example, the following can be conceived.

Facility Passing Time:

The learning degree is varied according to the time of passing the facility. Since the facility is difficult to recognize at night, the learning effect must be low.

Facility Passing Speed:

If the passing speed at the time of passing the facility is high, the facility is difficult to recognize, and therefore the learning effect must be low.

Facility Staying Time:

If the user stays at the facility, not only passing it, the learning effect must be high. It is can be assumed that the learning effect is higher as the staying time period is longer. However, the learning degree can be set to 100% if the user stays, regardless of the staying time period.

(b) Facility Factor

The facility factor is a parameter derived from a specific facility. For example, the following can be conceived.

Known Degree:

The learning effect is presumed to be high for a famous facility known to everybody.

View:

If the map database can include information of the shape of the facility and/or the obstacles, it can be determined how easily the building can be viewed, based on the traveling direction of the vehicle. The learning effect is presumed to be high for the building that can be easily viewed.

(c) Route Factor

The route factor is a parameter derived from, not only a specific facility, but the relation between the facilities along the route. For example, the following can be conceived.

Number of Facilities on the Route:

If the number of facilities is too large relative to the total distance of the route, the user cannot remember all of the facilities. Therefore, the learning effect is presumed to be low.

(d) Human Factor

The human factor is a parameter derived from the human being (a driver or a user). Foe example, the following can be conceived.

Taste:

User's taste for the facility is considered. The facility that the user is interested in easily remains in the memory of the user, and the learning effect is presumed to be high.

Line of Sight:

User's line of sight is detected by the detector of the line of sight. If the line of sight of the user is directed to the facility at the time of passing the facility, the learning effect is presumed to be high.

Physical Condition:

User's physical condition is detected by the detector of the physical condition, and the result is reflected in the learning effect. For example, in a situation being tired and/or lacking sleep, the concentration and/or the memorizing ability is low, and therefore the learning effect is presumed to be low.

Forgetfulness:

Deterioration of the learning degree of the facility due to the passage of time is considered. It is presumed that, the longer the time passes after visiting the facility, the lower the learning degree of the facility becomes.

In this way, by considering, not only the driving factor, but the facility factor, the route factor and the human factor as the parameter, it becomes possible to accurately judge whether or not the user is aware of the facility and reflect it in the learning degree.

As described above, the facility learning degree calculating unit 110 calculates the basic learning degree based on the number of times of passing each facility, and corrects it by using the above-mentioned various parameters to calculate the facility learning degree. The facility learning degree thus calculated is stored as a part of the facility data as shown in FIG. 3.

Next, the facility importance degree calculating unit 112 will be described in detail. The facility importance degree calculating unit 112 calculates the importance degree of facility. The facility whose importance degree is 0 is eliminated from the object of learning. By selecting the route in consideration of the importance degree of facility, it is possible to select the learning purpose candidate route more needed by the user.

There are conceived some parameters for calculating the importance degree. The examples of calculating methods of the importance degree will be described below.

The first method calculates the facilities that meet the taste of the user, and calculates the importance degree based on the taste information. For example, if it is known that the user has high interest in the facility of a specific genre based on the history of the route search and/or the facility search made by the user in the past, the facility importance degree calculating unit 112 sets a high importance degree to the facility of that genre.

The second method sets the importance degree of the facility of a specific category under a specific condition. For example, if the user just recently moved to the area and is not familiar with that area, the facilities that appear to be necessary for daily life, such as a city hall, a hospital and a supermarket are set to the facility of learning object. The navigation apparatus can determine that the user has moved, when the registered position of the user's home is changed.

While the importance degree is basically automatically calculated by the facility importance degree calculating unit 112, it can be manually set by the user's input. The importance degree thus obtained is stored as a part of the facility data as shown in FIG. 3.

Next, the learning purpose route calculating unit 114 will be described in detail. The route searching unit 105 executes the route search based on the search condition designated by the user, and calculates a plurality of candidate routes to the destination. The learning purpose route calculating unit 114 calculates the learning effect for each of the facilities on the candidate routes, based on the facility learning degree calculated by the facility learning degree calculating unit 110. Here, the learning effect indicates the increasing rate of the facility learning degree caused by passing a certain facility. For example, as to a certain facility, it is assumed that the facility learning degree is “0%” when the number of times of the passage is 0 time, that the facility learning degree is “50%” when the number of times of the passage is 1 time, that the facility learning degree is “75%” when the number of times of the passage is 2 times, and that the facility learning degree is “87.5%” when the number of times of the passage is 3 times. In this case, the learning effect obtained by passing the facility for the first time is “50%”, the learning effect obtained by passing the facility at the second time is “25%”, and the learning effect obtained by passing the facility at the third time is “12.5%”.

Namely, the learning effect is obtained by subtracting “the learning degree at present” from “the learning degree after the passage of next time”. Now, assuming that the learning degree is “g” and the number of times of the passage at present is “x”, the learning effect g is obtained by the following equation.

Learning Effect g=Learning Degree(x+1)−Learning Degree(x) (2)

When the learning effect for each of the facilities on the candidate routes is thus obtained, the learning purpose route calculating unit 114 calculates the learning effect point for each of the candidate routes (hereinafter referred to as “route-based learning effect point”). At that time, the learning purpose route calculating unit 114 can simply set the total of the learning effects for the plurality of the facilities on each of the candidate routes to the route-based learning effect point.

Alternatively, weighted addition by the importance degree can be performed like the present invention. In this case, the total of the learning effects of each facility after the weighted addition by the importance degree (hereinafter referred to as “weighted learning degree”) is the route-based learning effect point. Specifically, assuming now that the number of the facilities on the candidate route is “n”, the learning effect of the n-th facility obtained by traveling the candidate route is “gₙ”, and the importance degree of the n-th facility is “iₙ”, the weighted learning effect Pₙ of each facility is obtained by the equation (3), and the learning effect point P of each route is obtained by the equation (4). It is noted that the route-based learning effect point corresponds to the facility learning effect index according to the present invention. The candidate route having higher route-based learning effect point is the route having higher learning effect for the facility.

$$\begin{matrix}{P}_{1} = {g}_{1} \times {i}_{1} \\ {P}_{2} = {g}_{2} \times {i}_{2} \\ {P}_{3} = {g}_{3} \times {i}_{3} \\ … \\ {P}_{n} = {\dot{g}}_{n} \times {i}_{n} & ( 3 ) \\ P = {\sum }_{k = 1}^{n} {P}_{k} & ( 4 )\end{matrix}$$

In this way, the route-based learning effect point is calculated for each of the plurality of candidate routes obtained by the route searching unit 106. The learning purpose route calculating unit 114 presents the candidate routes to the user based on the route-based learning effect point thus obtained.

There are conceived some methods to present the candidate routes to the user. For example, the first presenting method automatically sets the route having highest route-based learning effect point to the route. The second presenting method displays a plurality of candidate routes on the display 44 of the display unit 40 in an order from the one having a higher route-based learning effect point to the one having a lower route-based learning effect point, and makes the user select one of them as the guiding route.

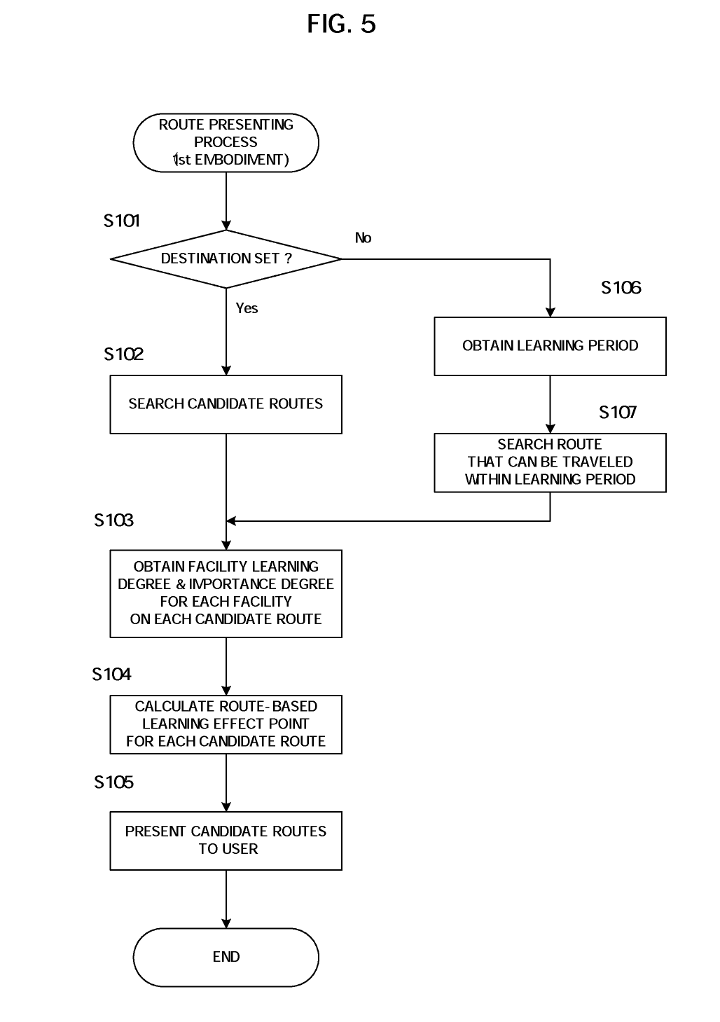

Next, the route presenting process will be described. FIG. 5 is a flowchart showing the route presenting process according to the first embodiment. This process is mainly executed by the route searching unit 105 and the learning purpose route calculating unit 114 shown in FIG. 2. It is noted that the route is presented to the user in two cases. In a first case, if the user sets the destination and instructs the route search, the route having high learning effect of facility is presented as the route to the destination. In a second case, if the user does not designate the destination, the route passing a plurality of facilities and returns to the starting point is presented.

First, the learning purpose route calculating unit 114 determines whether or not the destination has been set by the user (step S101). If the destination has already been set (step S101; Yes), the route searching unit 105 executes the route search to the destination, and calculates a plurality of candidate routes (step S102). Next, the learning purpose route calculating unit 114 obtains the facility learning degree and the importance degree for each facility on each of the candidate routes (step S103), and calculates the route-based learning effect points by using the aforementioned equations (2) to (4) (step S104). Then, the learning purpose route calculating unit 114 presents the candidate routes to the user by the first or second presenting method described above (step S105).

On the other hand, if the destination has not been set by the user (step S101; No), the learning purpose route calculating unit 114 requests the user to input the learning period and obtains the learning period (step S106). Here, the learning period is a time period in which the user can travel for the purpose of learning the facilities. Then, the route searching unit 105 searches for the candidate route, whose starting point and destination are the current position and which can be traveled within the learning period inputted by the user (step S107). Thereafter, similarly to the case where the user sets the destination, the route-based learning effect point is calculated for each of the candidate routes, and the candidate routes are presented to the user (steps S103 to S105).

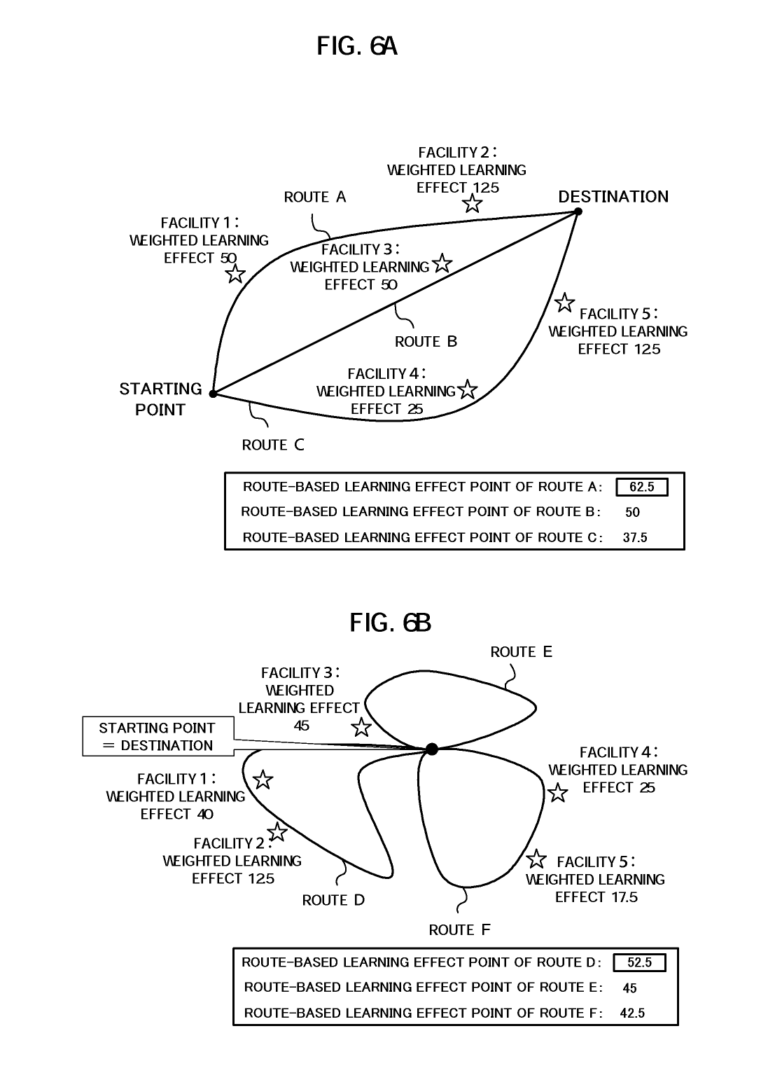

FIGS. 6A and 6B show the examples of determining the candidate routes. FIG. 6A shows the example of determining the candidate routes when the user sets the destination. The routes A to C are searched as the candidate routes from the staring point to the destination, and the weighted learning effect is calculated for each of the facilities on each route. The weighted learning effect is the learning effect after the weighting correction by the importance degree described above. The total of the weighted learning effects is the route-based learning effect point of each of the routes A to C, and the route A having the largest route-based learning effect point is set as the guiding route.

FIG. 6B shows the example of determining the candidate routes when the user does not set the destination. In this case, the routes D to F are searched as the candidate routes, and the route-based learning effect point is calculated for each of the routes. The route D having the largest route-based learning effect point is determined as the guiding route.

As described above, according to the first embodiment, the learning effect point is calculated for each of the candidate routes, and the candidate route having high learning effect with respect to the facility is presented. Therefore, by traveling the route having high learning effect point, the user can obtain the knowledge about the facilities on the route. Basically, the user does not have a business on the road itself, but has a business on the facility along the road. Therefore, if the facility is not learned, the facility is eliminated from the object of learning, even if the road is learned. In this embodiment, such a situation can be reduced by making the user learn the facility, and thereby efficient driving can be achieved.

### 2nd Embodiment

Next, the second embodiment will be described. In the first embodiment, basically when the user performs the route search, the learning purpose candidate route having high learning effect of facility is presented. However, always presenting the learning purpose candidate route is problematic for the user, e.g., when the user is in a hurry. In this view, in the second embodiment, it is determined how much degree of margin the user has, and the learning purpose candidate route is presented within the range. Namely, a margin determining unit determines whether the user has a margin to travel the candidate route, e.g., whether or not the desired arrival time has been set, at the time of determining the route to be presented to the user from a plurality of candidate routes, and only the route that passed the determination is used as the learning purpose candidate route.

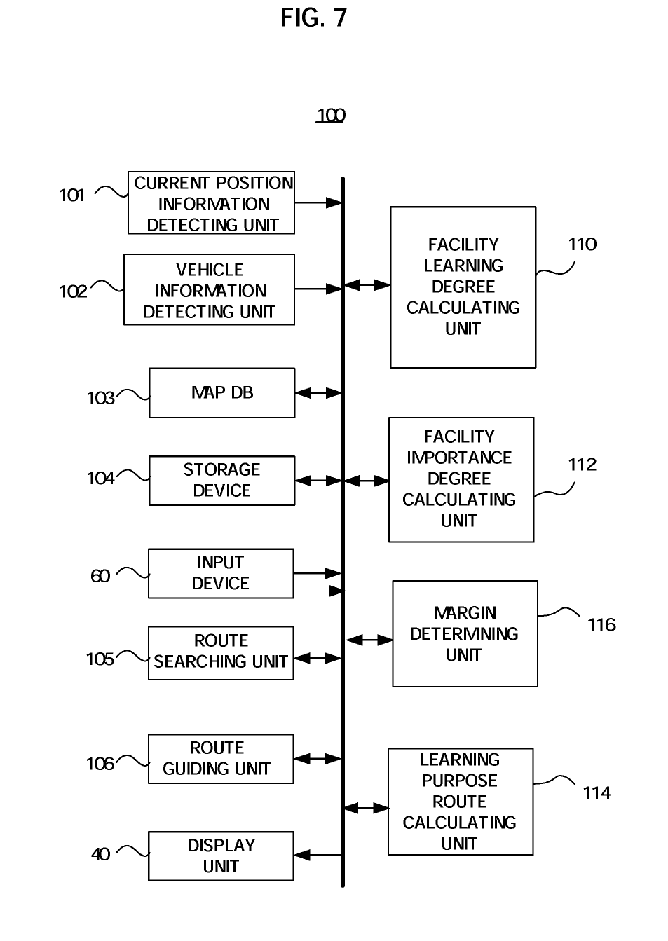

The functional block diagram of the navigation apparatus 100 according to the second embodiment is shown in FIG. 7. As shown, the configuration of the second embodiment is the same as the configuration of the first embodiment, except that the margin determining unit 116 is added.

The margin determining unit 116 determines whether or not the user has the margin to travel the learning purpose route, specifically whether each of the candidate route satisfies margin condition or not. The margin determining unit 116 determines the margin for each of the candidate routes, and presents only the candidate routes having the margin to the user as the learning purpose candidate routes.

As the kind of the margin, there are conceived three margins, i.e., a time margin, a physical condition margin and a driving operation margin.

(a) Time Margin

In a case that the desired arrival time to the destination has been set, it is necessary to reach the destination within the time. The route by which the user cannot reach the destination within the time is not used as the learning purpose candidate route, no matter how its learning effect is high. Basically, the time margin depends on the designation by the user. For example, the time margin is calculated based on the desired arrival time designated by the user. However, in a case of commute, the working starting time of the company may be set in advance so that the margin determining unit 116 automatically calculate the margin in relation with the current time. In this way, by traveling the learning purpose route only when there is a time margin, the delayed arrival to the destination can be avoided. Also, by assigning the margin time to the learning of the facility, the time can be efficiently used.

(b) Physical Condition Margin

Since the learning purpose route is not the shortest route, the driving time may be increased in comparison with the shortest route. If the user is not in a good physical condition, such as being tired, lacking sleep or the like, the route having less physical burden to the user should be presented in consideration of the driving time and/or the road width, no matter how high the learning effect is. In this view, if it is judged that the user is not in a good physical condition, the learning purpose route is not presented. The physical condition can be judged based on the biological information of the driver (e.g., heart rate) and/or sleeping hours, for example. In a case that the heart rate is higher than the normal value and/or the sleeping hours is short, it is desirable to present a safe route even if its learning effect is low. In this way, considering the physical condition margin leads to the prevention of accidents. Since this is true for all of the candidate routes, it is not necessary to perform this for each of the candidate routes, and it is enough to perform once.

(c) Driving Operation Margin

Since a user who is not well experienced in driving concentrates on the driving operation, he cannot afford to learn the facilities along the road, and hence the learning effect appears to be low. Also, the route having high learning effect is not necessarily the route easy to drive. In this view, if it is judged that the user's driving skill is low, the route is presented with giving the priority, not to the learning effect, but to the driving easiness. It is noted that the driving skill and/or the experience can be set in advance in the navigation apparatus as the user information.

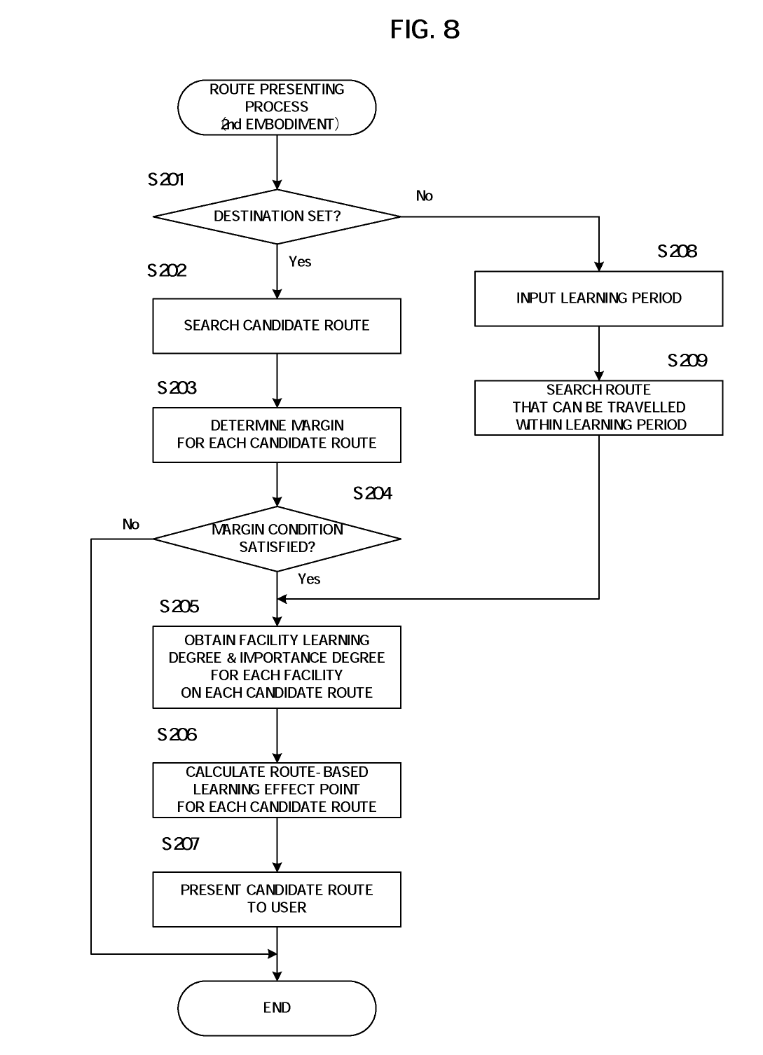

FIG. 8 is a flowchart of the route presenting process according to the second embodiment. This process is mainly executed by the route searching unit 105, the learning purpose route calculating unit 114 and the margin determining unit 116.

First, the learning purpose route calculating unit 114 determines whether or not the destination has been set by the user (step S201). If the destination has been set (step S201; Yes), the route searching unit 105 executes the route search to the destination, and calculates a plurality of candidate routes (step S202). The margin determining unit 116 determines the margin for each of the candidate routes (step S203).

If there is not any candidate route that satisfies the margin condition (step S204; No), the process ends. If there is a candidate route that satisfies the margin condition (step S204; Yes), the learning purpose route calculating unit 114 obtains the facility learning degree and the importance degree of the each of the facilities on each of the candidate routes from the facility data (step S205), and calculates the route-based learning effect points (step S206). Then, the learning purpose route calculating unit 114 presents the candidate routes to the user by the first or the second presenting method described above (step S207).

On the other hand, if the destination has not been set by the user (step S201; No), the learning purpose route calculating unit 114 requests the input of the learning period to the user, and obtains the learning period (step S208). Then, the route searching unit 105 searches for the route, whose starting point and destination are the current position and which can be traveled within the learning period inputted by the user (step S209). If the user has not set the destination, it can be presumed that the user has the margin. Therefore, the route-based learning effect point is calculated for each of the candidate routes, and the candidate routes are presented to the user (step S205 to S207).

As described above, in the second embodiment, since the learning purpose route is presented within the range of the margin of the user, the route having high learning effect can be present within the range that the situation permits.

While the candidate routes are selected in consideration of the margin at the time of the route search in the above example, the application of the present invention is not limited to this example. For example, the margin can be periodically judged during the travel along the guiding route, and if the margin no longer exists, the route from the position to the destination, having the shortest distance or shortest time, can be searched again.

### INDUSTRIAL APPLICABILITY

This invention can be used for various terminal device having a route search function, such as a personal computer, a cell phone, a portable terminal device and a game machine, as well as a car navigation apparatus.

1. A route searching apparatus comprising:
a route searching means which performs a route search according to a search condition;
an index calculating means which calculates a facility learning effect index indicating a degree of learning effect of a user with respect to a facility existing along a route, for each of candidate routes obtained by the route search; and
a candidate route presenting means which presents candidate routes based on the facility learning effect index.

2. The route searching apparatus according to claim 1, wherein the index calculating means comprises:
a learning effect calculating means which calculates a facility learning effect indicating learning effect of the user with respect to each of facilities existing along the candidate routes; and
a learning effect index calculating means which calculates a total of the facility learning effects of all the facilities existing along the candidate route as the facility learning effect index.

3. The route searching apparatus according to claim 1, wherein the index calculating means comprises:
a learning effect calculating means which calculates a facility learning effect indicating learning effect of the user with respect to each of the facilities existing along the candidate routes;
a correcting means which corrects the facility learning effect by an importance degree set to the facility; and
a learning effect index calculating means which calculates a total of corrected facility learning effects of all the facilities existing along the candidate route as the facility learning effect index.

4. The route searching apparatus according to claim 1, further comprising a margin determining means which determines whether or not the candidate route satisfies a margin condition,
wherein the index calculating means calculates the facility learning effect index only for the candidate route satisfying the margin condition.

5. The route searching apparatus according to claim 4, wherein the margin condition is a necessary time to a destination set in advance.

6. The route searching apparatus according to claim 1, wherein the candidate route presenting means sets the candidate route having a highest learning effect index to a guiding route.

7. The route searching apparatus according to claim 1, wherein the candidate route presenting means presents the candidate routes in an order from the candidate route having a higher learning effect index.

8. A route searching method comprising:
a route searching process which performs a route search according to a search condition;
an index calculating process which calculates a facility learning effect index indicating a degree of learning effect of a user with respect to a facility existing along a route, for each of candidate routes obtained by the route search; and
a candidate route presenting process which presents candidate routes based on the facility learning effect index.

9. A route searching program on a computer-readable medium and executed by a terminal device including a computer, making the computer function as:
a route searching means which performs a route search according to a search condition;
an index calculating means which calculates a facility learning effect index indicating a degree of learning effect of a user with respect to a facility existing on a route, for each of candidate routes obtained by the route search; and
a candidate route presenting means which present candidate routes based on the facility learning effect index.

10. The route searching apparatus according to claim 2, further comprising a margin determining means which determines whether or not the candidate route satisfies a margin condition,
wherein the index calculating means calculates the facility learning effect index only for the candidate route satisfying the margin condition.

11. The route searching apparatus according to claim 3, further comprising a margin determining means which determines whether or not the candidate route satisfies a margin condition,
wherein the index calculating means calculates the facility learning effect index only for the candidate route satisfying the margin condition.

12. The route searching apparatus according to claim 2, wherein the candidate route presenting means sets the candidate route having a highest learning effect index to a guiding route.

13. The route searching apparatus according to claim 3, wherein the candidate route presenting means sets the candidate route having a highest learning effect index to a guiding route.

14. The route searching apparatus according to claim 4, wherein the candidate route presenting means sets the candidate route having a highest learning effect index to a guiding route.

15. The route searching apparatus according to claim 5, wherein the candidate route presenting means sets the candidate route having a highest learning effect index to a guiding route.

16. The route searching apparatus according to claim 2, wherein the candidate route presenting means presents the candidate routes in an order from the candidate route having a higher learning effect index.

17. The route searching apparatus according to claim 3, wherein the candidate route presenting means presents the candidate routes in an order from the candidate route having a higher learning effect index.

18. The route searching apparatus according to claim 4, wherein the candidate route presenting means presents the candidate routes in an order from the candidate route having a higher learning effect index.

19. The route searching apparatus according to claim 5, wherein the candidate route presenting means presents the candidate routes in an order from the candidate route having a higher learning effect index.
